(19) United States
(12) Patent Application Publication
(10) Pub. No.: US 2016/0298272 A1
(43) Pub. Date: Oct. 13, 2016

(54) LACE WALLPAPER

(71) Applicant: Kyung Hye Cho, Seoul (KR)

(72) Inventor: Kyung Hye Cho, Seoul (KR)

(21) Appl. No.: 15/094,782

(22) Filed: Apr. 8, 2016

Related U.S. Application Data
(63) Continuation-in-part of application No. PCT/KR2015/008543, filed on Aug. 17, 2015.

(30) Foreign Application Priority Data
Aug. 26, 2014 (KR) 10-2014-0111216
Oct. 27, 2014 (KR) 10-2014-0145796

(51) Int. Cl. D04B 21/06; B32B 7/12; B32B 5/02

(52) U.S. Cl. CPC D04B 21/06; B32B 5/026; B32B 7/12; B32B 2607/02; D10B 2503/04

(57) ABSTRACT

A lace wallpaper is described, which includes a lace fabric, which includes a design pattern that includes about 10% to about 95% of a covering area in which a thread of a knit structure forms a surface and about 5% to about 90% of an opening area in which the thread of the knit structure does not form the surface. The rear surface of the covering area is configured as an even surface. A hot melt coating layer is formed by applying a hot melt adhesive made of a thermoplastic resin on the rear surface. A rear sheet of which one surface is adhered to the lace fabric by using the hot melt coating layer as a medium and exposed through the opening area.

### CROSS-REFERENCE TO RELATED APPLICATIONS

This patent document is a continuation-in-part application of, and claims priority and benefits of, Patent Cooperation Treaty (PCT) Application No. PCT/KR2015/008543, entitled “LACE WALLPAPER”, filed with the Korean Intellectual Property Office (KIPO) on Aug. 17, 2015, which further claims priority of Korean Patent Application No. 10-2014-0111216, filed Aug. 26, 2014, and Korean Patent Application No. 10-2014-0145796, filed on Oct. 27, 2014. The entire disclosures of the above applications are incorporated by reference in their entirety.

### TECHNICAL FIELD

The disclosed technology relates to wallpaper, and in particular, an aesthetically improved point wallpaper.

### BACKGROUND

Typically, wallpaper is put onto wall surfaces to decorate and protect the interior wall surfaces of various buildings, and to prevent dew condensation effects. Such wallpaper may be classified according to material as paper wallpaper, textile wallpaper, silk wallpaper, and foaming wallpaper. Some wallpaper covers the entire surface of the wall, but point wallpaper that covers only a part of the wall is also being widely used.

Recently, the general public's interest in interior decoration has met with diversified tastes to increase interest in textile wallpaper. Textile wallpaper is a wallpaper composed of layers of cloth, fabric, etc., instead of paper, and benefits from characteristic of textiles in having excellent heat retention, absorptive, and noise dampening properties. In particular, a textile wallpaper breaks free from limits of simple wallpaper patterns and thus is suitable for consumers who prefer diverse and luxurious interior designs. For example, by using textile wallpaper to cover an entire wall surface or as some point wallpaper, the consistent and comfortable texture that textile materials have may be conveyed to the occupants.

### SUMMARY

Some implementations of the disclosed technology provide a lace wallpaper capable of breathing new life into the wallpaper design industry, and to which a lace fabric is adhered. Due to a fancy and luxurious material of the lace fabric, the lace wallpaper may in particular be used as a point wallpaper in various parts of a house to create an elegant and tasteful atmosphere.

Moreover, through various combinations of a lace fabric and a rear sheet that is exposed through an opening area of the lace fabric, designs of various shapes may be created.

In particular, the disclosed technology effectively overcomes a technical limitation in which adhering the lace fabric with a low covering area to the rear sheet is extremely difficult. The disclosed technology allows an economical manufacture of lace wallpaper, by making the wallpaper design amenable to easy manufacturing of lace wallpaper. Thus, some implementations of the disclosed technology use a simple manufacturing process by which a manufacturer puts the specially manufactured lace fabric on the rear sheet and applies heat and pressure to integrate the lace fabric and rear sheet.

Other uses of the disclosed technology, which are easily inferred within the scope of the following detailed description and advantageous effects thereof, may be considered by one of skilled in the art.

In one aspect, a lace wallpaper is disclosed. The wallpaper includes a lace fabric. The lace fabric includes a covering area that covers about 10% to about 95% of the lace fabric and has a surface with a thread of a knit structure and an opening area which covers about 5% to about 90% of the lace fabric and has a surface without the thread of the knit structure. The covering area has an uneven front surface on which a lace motif design pattern layer is formed to provide a plurality of layers and the covering area has an even rear surface.

Here, the hot melt coating layer disposed on the rear surface of the covering area of the lace fabric may include a first paste dot layer and a second paste dot layer, which are laminated in sequence, and a paste adhesive may be applied on the rear surface of the covering area through roll printing to form the first paste dot layer, and then hot melt powder may be scattered onto the first paste dot layer to form the second paste dot layer.

Moreover, the surface of the covering area may be configured as the uneven surface composed of layers different from each other because a thread of the lace fabric is woven, and a pattern member formed of a material different from that of the woven thread is woven again on the woven thread of the lace fabric to form the lace motif.

Furthermore, in the paste that is used for forming the hot melt coating layer, the paste that is used for the first paste dot layer may be equal to or different from the paste that is used for the second paste dot layer.

According to a lace wallpaper of the disclosed technology, by allowing a user to use wallpaper that is decorated with lace, an aesthetic effect of an interior design may be advantageously enhanced, and by allowing a manufacturer to manufacture a novel lace wallpaper in a simple and easy manner, competitiveness may be improved.

Since the user may use the novel lace wallpaper of the disclosed technology in the same way as a typical wallpaper, there are no difficulties presented by the disclosed technology. Likewise, from the perspective of the manufacturer, since the lace fabric of the disclosed technology is easily adhered on the rear sheet, which is manufactured by traditional methods, and thereby integrated, there are no technical difficulties experienced in the manufacture of the novel lace wallpaper.

Meanwhile, even if not explicitly stated herein, advantageous effects that are disclosed in or inferred from the contents of the below specification and may be anticipated by the technical features of the disclosed technology, will be treated the same as those that are disclosed in the specification of the disclosed technology.

### BRIEF DESCRIPTION OF THE DRAWINGS

FIG. 1 is a cross-sectional view of an example lace wallpaper according to an embodiment of the disclosed technology.

FIG. 2 is a diagram illustrating an exemplary surface configuration of a lace fabric according to an embodiment of the disclosed technology.

FIG. 3. illustrates an exemplary rear surface configuration of a lace fabric in FIG. 1.

FIG. 4 is a diagram illustrating an example of a method for manufacturing a lace fabric according to an embodiment of the disclosed technology.

FIG. 5 is a flow sheet showing an example of a method for manufacturing a lace wallpaper according to an embodiment of the disclosed technology.

FIG. 6 is a flow sheet showing a method for manufacturing a lace sheet member according to another embodiment of the disclosed technology.

The accompanying drawings are provided merely as examples for better understanding the technical spirit of the disclosed technology, and should not be construed as limiting the scope of the disclosed technology.

### DETAILED DESCRIPTION

As one of materials for such textile wallpaper, lace fabric, which is characterized by its fancy appearance and luxuriousness, may be considered. However, significant technical difficulties are faced when using such lace fabrics for textile wallpaper. In order to function as a wallpaper, a rear sheet that adheres to the lace fabric and also adheres to a wall should be easily affixable to the lace fabric, but such an adhering process is difficult.

Lace fabric, unlike other common textiles used as material for textile wallpaper, is typically manufactured by knitting with a warp knitting machine, and since the lace fabric has many holes, the fact that the area of the total surface that is occupied by an adhering surface is extremely small is a practical limitation. A mesh structure may be found in various fabrics. Representative examples include nonwoven fabrics that form a plane through interlocking between fabrics, and knitted fabrics that form a mesh structure of warp and weft. Since, in such nonwoven or knitted fabrics, the area occupied by the warp and weft (or fiber) per unit area, that is, covering degree, of the fabric is large, the task of adhering the fabric to the rear sheet is not difficult. However, since, in lace fabrics, the covering degree is extremely small and the fabric is the same, the job of adhering the fabric to the rear sheet is made difficult.

Thus, the inventors have examined methods for cutting fabric to a desired size and then bonding the cut lace fabric to the rear sheet by using an adhesive. However, for a user using lace fabric, the job of directly applying the adhesive to the rear surface of the lace fabric is still difficult due to the low covering degree of the lace fabric. Therefore, applying a technique of forming an adhesive layer on one surface of the lace fabric during a process of manufacturing the lace fabric was considered to be better. For example, the method for manufacturing fabric that adheres to clothing through heating, disclosed in Korean Patent No. 549816, may be considered.

This prior art patent document does not relate to lace fabric, but instead to a fabric on which is formed an ornamental pattern, and discloses a technique in which, after using a roller to laminate an adhesive film on an ornamental fabric, a half cutter of the manufacturing apparatus is used to repeatedly cut the laminated fabric. However, this typical technique cannot be applied to the lace fabric. The reason being that, first, since the design of the lace fabric is extremely varied, it is inconvenient and uneconomical to adjust a cutting pattern of the half cutter in the manufacturing apparatus. Moreover, since the lace fabric includes a roughness of a weave and numerous holes, and thus cannot be sufficiently laminated with the adhesive film, it is difficult to adhere the lace fabric to the adherend. Even if the adhesive film is adhered to the lace fabric, there is a critical limitation of the user being unable, due to the many holes, to separate the adhesive film from the lace fabric.

In one advantageous aspect, a lace wallpaper of the disclosed technology is configured such that a lace fabric is integrated with a rear sheet of the wallpaper. Thereby, the lace wallpaper with the lace fabric adhered is provided.

Most of the lace fabric is fabric that is warp knitted with a warp knitting machine, and diverse designs of the fabric are made by making various changes to knitting structure. Such lace fabric allows elegant and fancy expression through the tasteful and luxurious texture, provided by the knit structure, of the material itself, and through the various designs created by modifications thereto. For such reasons, lace fabric has mostly been used for the decoration of clothing or furniture. However, by using lace fabric in wallpaper, which is used for protecting interior wall surfaces in buildings, the disclosed technology allows the tasteful and luxurious image provided by lace fabric to be expressed not only in clothing or furniture, but also in an entire home or parts of an office.

Hereinafter, with reference to the accompanying drawings, detailed description will be given of modes for carrying out the disclosed technology. In describing the disclosed technology, detailed descriptions of known techniques that are obvious to a person with ordinary skill in the art will be excluded so as not to unnecessarily obscure the essence of the disclosed technology.

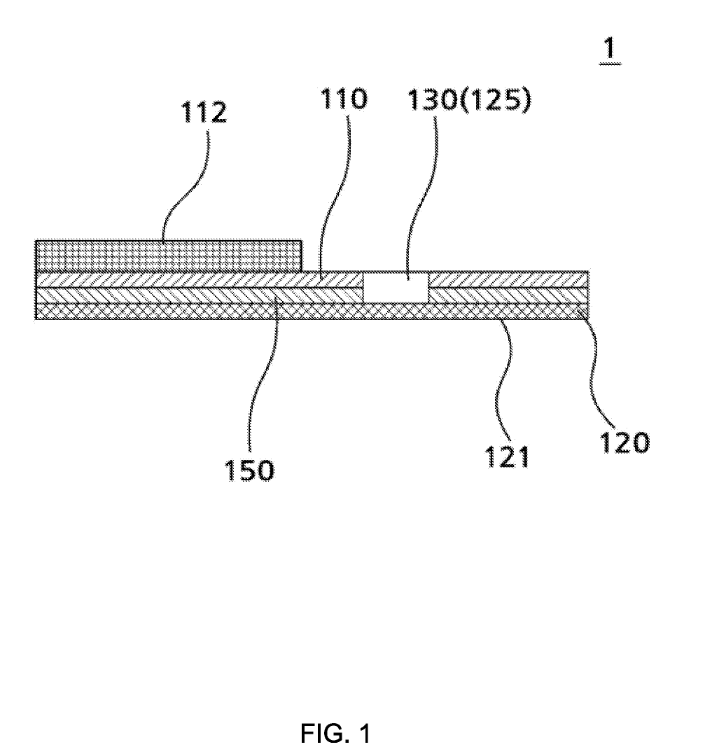

FIG. 1 is a cross-sectional view schematically displaying an exemplary configuration of the lace wallpaper 1 of the disclosed technology. As is illustrated in FIG. 1, the lace wallpaper 1 according to the disclosed technology is configured to include a pattern member 112, a lace fabric including a covering area 110 and an opening area 130, a hot melt coating layer 150, and a rear sheet 120.

The lace fabric includes the covering area 110 in which a knit structure thread forms a surface thereof, and the opening area 130 in which the knit structure is not present. A rear surface of the lace fabric is configured to be an even surface and the surface of the lace fabric is configured to be an uneven surface. The even surface is adhered to the rear sheet 120 by using the hot melt coating layer 150 as a medium and thus unexposed, but the uneven surface is externally exposed.

First, the configuration of the uneven surface is described hereafter. When the pattern member 112 layer is formed on the covering area 110 of the lace fabric, the surface of the lace fabric forms an uneven surface due to the pattern member 112. That is, the surface of the lace fabric is provided with a plurality of layers due to the pattern member 112. Thus, because the pattern member 112 is rewoven on the covering area 110, a design motif may be expressed, which allows the diverse expression of not only density of the lace structure and thickness of a thread, but also lace pattern and texture. The pattern member 112 may be appropriately a different member than the thread making up the lace fabric. When the pattern member 112 is added in such a way on the covering area 110, ridges with members that have different heights from each other are formed such that the surface of the fabric forms the uneven surface.

The rear surface of the lace fabric excludes the pattern member 112 that is formed on the surface, and thus the covering area 100 of the rear surface forms the relatively even surface. The hot melt coating layer 150 is disposed on the covering area 110, and, by undergoing a process in which heat and pressure are applied, adhered to the rear sheet 120. By configuring as such, a portion of one surface of the rear sheet 120 may be externally exposed through the opening area 130. Such a configuration of the disclosed technology enhances the spatial effect of the lace wallpaper 1 and allows various design configurations. Since texture, color, and the like, of the rear sheet 120 differs from that of the lace fabric and is externally exposed through an externally exposed area 125, the utility of the lace wallpaper 1 may be improved.

The lace wallpaper 1 according to the disclosed technology may not only be used as wallpaper for the entire house, but may also be used as point wallpaper in places desired by the user. By using as the point wallpaper the lace wallpaper including the lace fabric, an elegant and tasteful design may be expressed, in various parts of the house desired by the user, through the fancy and luxurious texture that is characteristic of the lace fabric.

In the case of the rear sheet 120, the surface that is in a direction opposite to the lace fabric is put on the wall. Here, the user puts the rear sheet on the wall after applying a wallpapering adhesive. Typically, the rear sheet 120 may be appropriately a laminated paper wallpaper, but the unmodified paper may also be used, and the rear sheet including a resin layer or print layer may also be desirable. Moreover, the rear sheet provided with diverse functionality such as water resistance, radiating material, crack resistance, fire resistance, durability, etc. may also be appropriate. Furthermore, an adhesive tape or a release paper may also be further added to the rear sheet surface 120 that adheres to the wall surface.

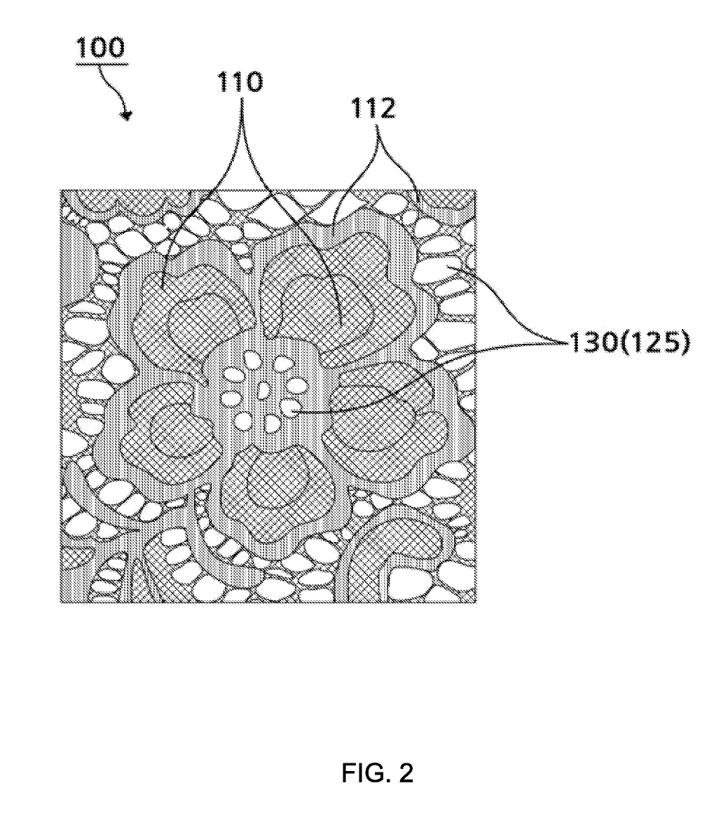

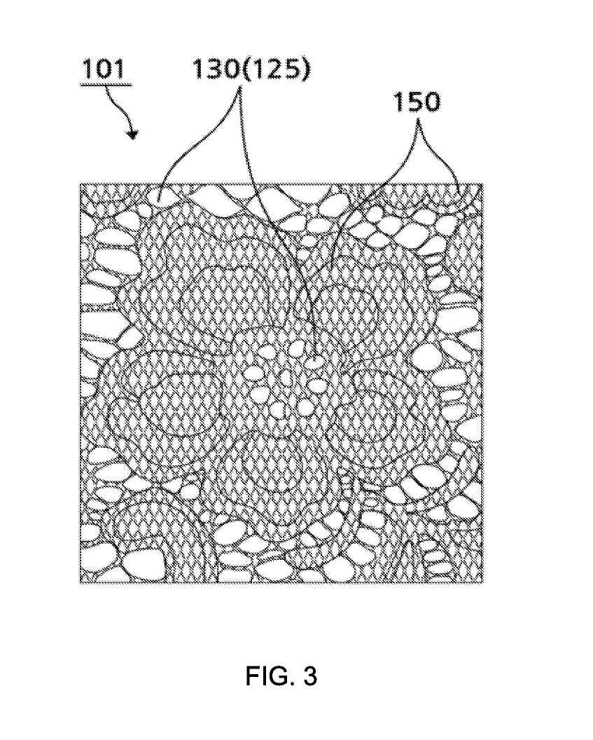

FIG. 2 schematically illustrates an exemplary surface 100 configuration of the lace fabric of the disclosed technology, and FIG. 3 schematically illustrates an exemplary rear surface configuration 101 of the lace fabric of the disclosed technology. There are no substantial differences between the respective configurations of the covering areas 110 and opening areas 130 of the surface 100 and rear surface 101. However, as described above, since the rear surface 101 of the lace fabric excludes the configuration of the plurality of layers provided by the pattern member 112 such as is shown in FIG. 1, the rear surface 101 forms the relatively even surface when compared to the surface 100. In the disclosed technology, the evenness of the rear surface 101 of the lace fabric does not indicate a physically perfect plane or flat surface, but instead indicates that the plane of the rear surface 101 is flatter than that of the surface 100.

As such, the surface of the lace wallpaper that uses the lace fabric is configured to be an uneven surface that provides a luxurious texture and a spatial effect, and the rear surface is configured to be an even surface such that a process of forming the hot melt coating layer, and a process of adhering and integrating the lace fabric to the rear surface sheet 120 under applied heat and pressure are efficiently achieved.

Meanwhile, it is further stated that the covering area 110 of the lace fabric does not exclude tiny holes. One reason is that, even though it is the covering area 110, mesh resulting from knitting is included. It is merely that the size of the mesh making up the holes differs for each position of the covering area 110.

The surface area ratio between the covering area 110 and opening area 130 of the lace fabric of the disclosed technology will be described. When the covering area 110 increases, there is more interlocking of the thread, and thus the externally exposed area 125 of the rear sheet 120 decreases. Conversely, the more the opening area 130 increases, the less the interlocking of the thread, and thus the externally exposed area 125 of the rear sheet increases. Desirably, the covering area 110 of the disclosed technology may, per unit area (for example, per square yard) occupy the surface area ratio of about 10% to about 95% of the lace fabric. When the surface area ratio of the covering area 110 is lower than about 10%, forming the hot melt coating layer 150 on the rear surface 101 of the lace fabric is difficult. When the surface area ratio is higher than about 95%, the holes become excessively small such that the use-value of the lace fabric may be reduced.

As described above, in the configuration of the front surface of the lace wallpaper 1 of the disclosed technology, the lace fabric and hot melt coating layer 150 are integrated. Thus, it is not the case that the user (wallpaper manufacturer) adheres the lace fabric to the rear sheet 120 after applying the adhesive to the lace fabric. In such a case, due to the property of the lace fabric of having a low covering area 110, a process of adhering to the rear sheet 120 is difficult, and the rate of failure is high. Since during the process of adhering the hot melt adhesive layer to the rear sheet 120, the hot melt adhesive may flow out through the opening area 130 at a boundary between the opening area 130 and the covering area 110 (Strike Back phenomenon), before adhering the lace fabric to the rear sheet 120 with the adhesive, the lace fabric needs to be integrated with the rear sheet 120 beforehand.

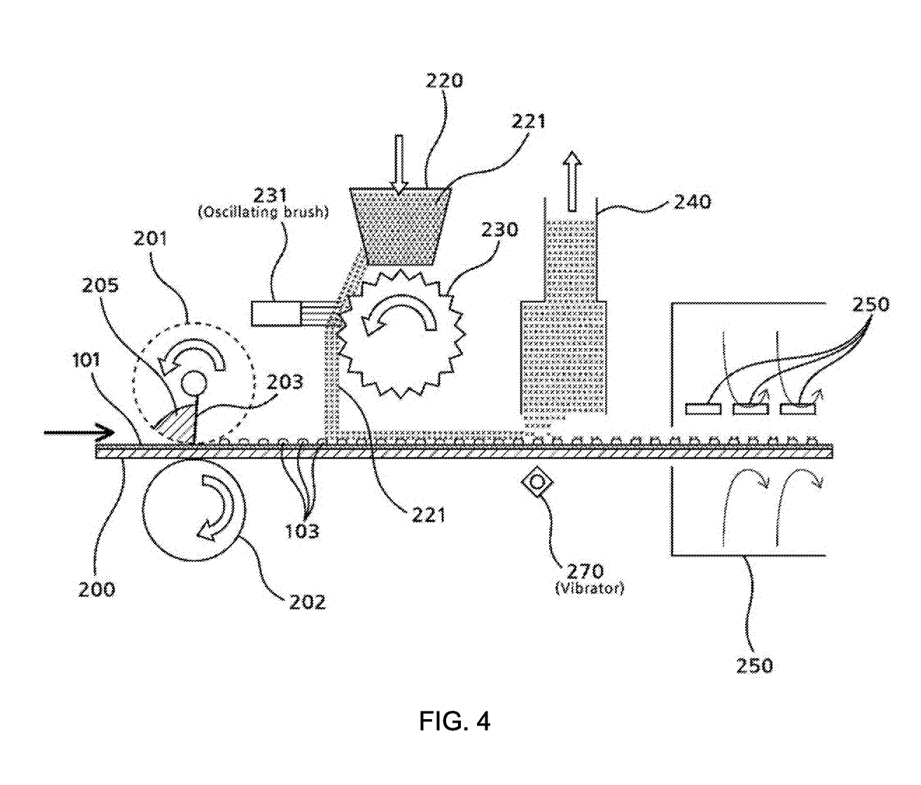

FIG. 4 conceptually illustrates a process of forming the hot melt coating layer 150 through an exemplary embodiment of the disclosed technology. The rear surface 101 of the lace fabric is disposed on the substrate 200, and the substrate 200 is transported in the direction of the arrow. Next, the hot melt coating layer 150 is prepared on the rear surface 101 of the lace fabric. Below, the method of preparing the hot melt coating layer 150 is described in detail.

First, using a rotating screen roller 201 and 202, a paste adhesive in a liquid state is applied in a manner similar to printing to thereby form a first paste dot layer 103 on the rear surface 101 of the fabric. Specifically, a doctor blade 203 of the screen roller 201 is made to print out base dots on the rear surface 101 of the lace fabric with paste 205.

In the composition of the paste, water occupies about 55 to about 70 wt % and has a role as a medium of dispersing the paste. Hot melt powder, about 25 to about 35 wt %, which makes up most of what is not water, may include polyamide hot melt or polyester hot melt. Desirably, dispersing agents, which are surfactants that act as wetting agents and function to facilitate a stable dispersion of the hot melt powder in the water; protective colloids, which are water soluble polymers that prevent each other from solidifying in the paste; plasticizers that bond with the hot melt adhesive to lower the melting temperature range and viscosity; lubricants that use polymer polyethylene glycol to facilitate a transfer of the dot from the screen to the lace fabric; and thickeners that use neutral polyacrylic acid to regulate the appropriate viscosity for the mechanical conditions may be further included. In addition, the paste may include plastic dispersing agents such as polyacrylate, polyurethane, latex, etc.

Various materials may be selected for the hot melt that is used in the disclosed technology. The hot melt materials such as styrene-based thermoplastic elastomer formed through alternating copolymerization of polystyrene blocks and blocks of polybutadiene and polyisoprene, ethylene-vinyl acetate-based resin containing between about 18 wt % to about 40 wt % of vinyl acetate, ethylene-acrylic acid copolymer, olefin-based resin, polyester-based resin, polyamide-based resin, polyurethane-based resin, etc. may be appropriately used.

Next, the about 80 to about 200 micron hot melt powder 221 inside a hopper 220 is provided to the lace fabric by a sputtering roller 230, and an oscillating brush 231 scatters the hot melt powder 221 onto the rear surface 101 of the lace fabric 1. Here, the hot melt powder 221 is disposed on the first paste dot layer 103 to form a second paste dot layer 105.

Afterwards, powder, other than the second paste dot layer 105 disposed on the first paste dot layer 103, is sucked up and removed by a suction apparatus 240. Next, the substrate 200 is passed through an air circulation-type chamber 250 to evaporate moisture contained in the dot layer of the lace fabric and dry the hot melt coating layer 150 that includes the paste dots. In a melting process, the second paste dot layer 105, which is the hot melt powder disposed on the first paste dot layer 103, melts, and at the same time is clumped together with the first paste dot layer 103. For completely drying, an infrared radiator 260 may be installed. The dots are cooled and solidified by undergoing a cooling operation, and by winding the lace fabric, the lace fabric that is provided with the hot melt coating layer 150 of the disclosed technology may be manufactured.

Desirably, it is advantageous for the dot weight of the first paste dot layer 103 to be about 3 to about 5 g/m², and the dot weight of the second paste dot layer 105 to be about 5 to about 7 g/m². The size of the dots may be regulated in various ways according to the design. Moreover, it is further stated that compositions of the hot melt powder used to form the first paste dot layer 103, and the hot melt powder used to form the second paste dot layer 105 may be combined in various ways.

The method for forming the hot melt coating layer on the lace fabric may be modified in various ways. For example, an embodiment in which only the method of forming the first paste dot layer 103 of FIG. 4 is used, and an embodiment in which the hot melt powder is transferred directly to the lace fabric may be considered for application. However, such methods have the disadvantages of an unsatisfactory coating job that is due to the characteristically extremely low covering degree of the lace fabric, and an easily occurring the strike back limitation. In particular, since in the latter method, the surface is hot melt coated by directly transferring high temperature heat to the lace fabric, it is difficult to apply the method to the lace fabric, which is thin and sensitive to heat.

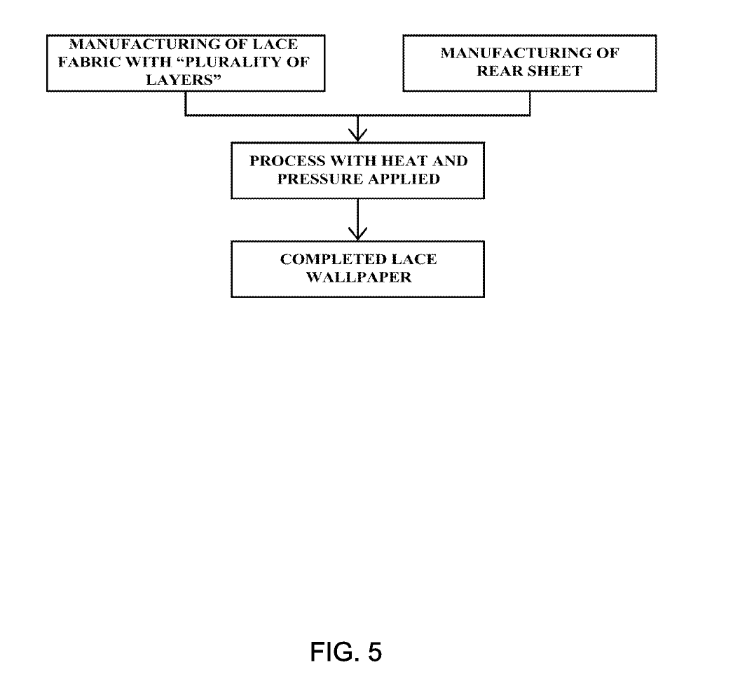

FIG. 5 illustrates an example process of manufacturing a lace wallpaper of the disclosed technology. As described above, the process of manufacturing the lace fabric and the process of manufacturing the rear sheet take place independently of each other. Moreover, two processes are integrated with each other through a process with heat and pressure applied, and thereby the lace wallpaper is completed. The process of manufacturing the lace fabric is, as described above, the integration of the lace fabric and the hot melt coating layer, and the formation of the hot melt coating layer on the covering area of the rear surface of the lace fabric through the process such as in FIG. 4. Such may be described as a first integration process.

In the process of manufacturing the rear sheet, widely known paper making techniques are used in a paper making mill. Next, a heat and pressure applying apparatus is pressed on surfaces of the lace fabric and rear sheet and then used by placing on the surface of the lace fabric, that is, the uneven surface and then applying heat and pressure at a temperature of at least 110° C., and desirably about 120° C. to about 170° C. Thereby, as the hot melt coating layer is melt, the rear surface of the lace fabric and the surface of the rear sheet are adhered to each other. The lace wallpaper is completed through such a second integration process. The surface of the rear sheet is externally exposed through the opening area of the lace fabric.

The method in which the user uses the lace wallpaper manufactured in such a manner has no difference with typical methods of putting up wallpaper.

In another embodiment of the disclosed technology, a lace sheet member may be provided instead of the lace wallpaper. The lace sheet member uses various sheet members instead of the rear sheet of the lace fabric such that the disclosed technology may be used for various uses beyond wallpaper. That is, various sheet members are applied to the lace fabric to provide a lace sheet member in which the lace fabric and sheet members are integrated.

Here, the lace fabric may be the same as the lace fabric used in the above-described lace wallpaper. That is, in the lace sheet member and lace wallpaper, the configuration in which the hot melt adhesive made of a thermoplastic resin is applied on the rear surface of the covering area of the lace fabric to form the hot melt coating layer is the same for each. In other words, the hot melt coating layer is formed on the rear surface of the covering area such that the lace fabric of the lace sheet member may be adhered to the sheet member.

By using the lace sheet member to which the lace fabric according to the disclosed technology and the sheet member are adhered, a subject article may be covered or packaged to decorate the subject article or add aesthetic beauty to the subject article, and protect the subject article from damage due to direct external exposure.

Specifically, the lace sheet member according to the disclosed technology may not only be used as a packaging member that packages products, but may also be used as an interior member for house interior design by covering electronic appliances and furniture in the house. By using the lace sheet member including the lace fabric as the packaging member of the product or as the interior member, the fancy and luxurious texture that is characteristic of lace fabric may be added to the product, and by covering the opening area of the lace fabric with the sheet member, the product being damaged by direct external exposure may be prevented.

Here, the sheet member may appropriately be one of a leather sheet, an artificial leather sheet, a textile sheet, a plastic sheet, or a paper sheet, having various types of patterns and colors and textures for packaging or decoration, and may appropriately include the resin layer or print layer. Moreover, diverse functionality may be advantageously added such as water resistance, radiating material, crack resistance, fire resistance, durability, etc.

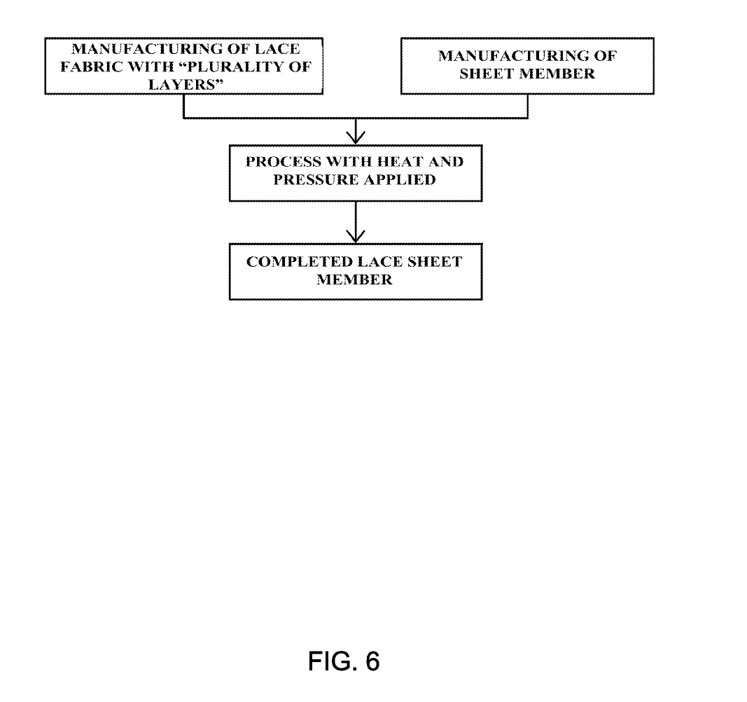

FIG. 6 is a flow chart showing an example method for manufacturing a lace sheet member according to another embodiment of the disclosed technology. Similar to the above-described method for manufacturing the lace wallpaper, in the manufacturing process for the lace sheet member, the process for manufacturing the lace fabric and the process for manufacturing the sheet member take place separately. Moreover, the separately manufactured lace fabric and sheet member are integrated with each other through the process with heat and pressure applied to thereby complete the lace sheet member.

The process of manufacturing the lace fabric is integrating the lace fabric and hot melt coating layer such as described above, and forming the hot melt coating layer through the process such as in FIG. 4 on the covering area of the rear surface of the lace fabric. Such may be described as the first integration process.

The process of manufacturing the sheet member uses the widely known paper making techniques of paper makers. Next, after pressing lace fabric, on which hot melt coating layer is formed, on the surface of the sheet member, the heat and pressure applying apparatus is used by placing on the surface of the lace fabric, that is, the uneven surface, and then applying heat and pressure at a temperature of at least about 110° C., and desirably about 120° C. to about 170° C. As a result, as the hot melt coating layer of the lace fabric melts, the rear surface of the lace fabric and surface of the sheet member become adhered to each other. Through such the second integration process, the lace sheet member is completed. The surface of the sheet member is externally exposed through the opening area of the lace fabric.

The lace sheet member manufactured as such is used as the packaging member or interior member for the product.

The scope of the disclosed technology is not limited to the clearly described Examples which are disclosed above. Moreover, it should be understood that the scope of the disclosed technology cannot be limited by modifications or substitutions that are obvious in the technical field.

1. A lace wallpaper, comprising:
a lace fabric comprising a covering area which covers about 10% to about 95% of the lace fabric and has a surface with a thread of a knit structure, and an opening area which covers about 5% to about 90% of the lace fabric and has a surface without the thread of the knit structure, wherein the covering area has an uneven front surface on which a lace motif design pattern layer is formed to provide a plurality of layers, and the covering area has an even rear surface;
a hot melt coating layer formed with a hot melt adhesive made of a thermoplastic resin on the rear surface of the covering area of the lace fabric; and
a rear sheet having one surface adhered to the lace fabric by using the hot melt coating layer as a medium and exposed through the opening area.

2. The lace wallpaper of claim 1, wherein the hot melt coating layer disposed on the rear surface of the covering area of the lace fabric comprises a first paste dot layer and a second paste dot layer that are laminated in sequence,
wherein a paste adhesive is applied on the rear surface of the covering area through roll printing to form the first paste dot layer, and then hot melt powder is scattered onto the first paste dot layer to form the second paste dot layer.

3. The lace wallpaper of claim 1, wherein the layers on the front surface of the covering area are different in height from one another due to a thread of the lace fabric woven, and the lace wall paper further includes a pattern member having a material different from that of the woven thread, the pattern member woven again on the woven thread of the lace fabric to form the lace motif.

4. The lace wallpaper of claim 2, wherein, the paste used for the first paste dot layer is same as or different from the paste used for the second paste dot layer.

5. A lace sheet member, comprising:
a lace fabric comprising a covering area which covers about 10% to about 95% of the lace fabric and has a surface with a thread of a knit structure, and an opening area which covers about 5% to about 90% of the lace fabric and has a surface without the thread of the knit structure, wherein the covering area has an uneven front surface on which a lace motif design pattern layer is disposed to provide a plurality of layers, and the covering area has an even rear surface;
a hot melt coating layer formed with a hot melt adhesive including a thermoplastic resin on the rear surface of the covering area of the lace fabric; and
a sheet member having one surface adhered to the lace fabric through the hot melt coating layer and exposed through the opening area,
wherein the layers on the front surface of the covering area are different in height from one another due to a thread of the lace fabric woven, and the lace sheet member includes a pattern member including a different material from that of the woven thread, the pattern member woven again on the woven thread of the lace fabric to form the lace motif design pattern layer, and
the sheet member comprises at least one of a leather sheet, an artificial leather sheet, a textile sheet, or a plastic sheet.

6. The lace sheet member of claim 5, wherein:
the hot melt coating layer disposed on the rear surface of the covering area of the lace fabric comprises a first paste dot layer and a second paste dot layer, which are laminated in sequence,
wherein a paste adhesive is applied on the rear surface of the covering area through roll printing to form the first paste dot layer, and then hot melt powder is scattered onto the first paste dot layer to form the second paste dot layer.

7. The lace sheet member of claim 6, wherein the paste used for the first paste dot layer is same as or different from the paste used for the second paste dot layer.
